(19) United States
(12) Patent Application Publication
(10) Pub. No.: US 2013/0133476 A1
(43) Pub. Date: May 30, 2013

(54) CENTRIFUGAL FORCE PENDULUM DEVICE

(71) Applicant: Schaeffler Technologies AG & Co. KG, Herzogenaurach (DE)

(72) Inventors: Eugen Kremer, Buehl (DE); Parviz Movlazada, Rastatt (DE)

(73) Assignee: SCHAEFFLER TECHNOLOGIES AG & CO. KG, Herzogenaurach (DE)

(21) Appl. No.: 13/722,256

(22) Filed: Dec. 20, 2012

Related U.S. Application Data
(63) Continuation of application No. PCT/DE2011/001273, filed on Jun. 20, 2011.

(30) Foreign Application Priority Data
Jun. 29, 2010 (DE) 102010025433.9

(51) Int. Cl. F16F 15/14

(52) U.S. Cl. CPC F16F 15/14
USPC 74/574.2

(57) ABSTRACT

A centrifugal force pendulum device having pendulum masses that are arranged axially on both sides of a pendulum mass carrier which is rotatable around an axis of rotation and form a pendulum mass pair, the pendulum mass pair being pivotable to a limited degree relative to the pendulum mass carrier along an arc-shaped oscillation path with the aid of at least two rolling elements that are able to roll in a single cutout or in different cutouts in the pendulum mass carrier, the oscillation path having a rotation axis that is stationary relative to the pendulum mass carrier and that is located at a radial distance from the pendulum mass.

### CROSS-REFERENCE TO RELATED APPLICATIONS

This application is filed under 35 U.S.C. §120 and §365(c) as a continuation of International Patent Application No. PCT/DE2011/001273 filed Jun. 20, 2011 and claims priority of German Patent Application No. 10 2010 025 433.9 filed Jun. 29, 2010, which applications are incorporated herein by reference to their entireties.

### FIELD OF THE INVENTION

The invention relates to a centrifugal force pendulum device.

### BACKGROUND OF THE INVENTION

A centrifugal force pendulum device of this sort active in a drivetrain of a motor vehicle is known from DE 10 2006 028 556 A1. The centrifugal force pendulum device for eliminating and/or damping torsional vibrations in the drivetrain comprises a pendulum mass carrier rotatable around a rotation axis and at least one pendulum mass pair arranged thereon consisting of two axially opposing pendulum masses attached to the two sides of the pendulum mass carrier, which are connected to each other with the help of attaching elements that reach through cutouts in the pendulum mass carrier.

The pendulum mass pair is suspended bifilarly with respect to the pendulum mass carrier by means of two rolling elements and are pivotable to a limited degree, the two rolling elements each being guided in cutouts in the pendulum mass carrier and in cutouts in each of the pendulum masses of the pendulum mass pair, and are able to roll therein. Because of the shape of the cutouts in the pendulum mass carrier and complementarily in the pendulum masses, an oscillation path of the pendulum mass pair is predetermined, which the latter can traverse under the influence of centrifugal force to eliminate torsional vibrations. While traversing the oscillation path, the pendulum mass pair is deflected translationally within a defined pivoting angle, in particular in the radial and circumferential directions, whereby torsional vibrations introduced into the pendulum mass carrier can be eliminated.

The design of the centrifugal force pendulum, in particular based on the oscillation interval as the distance of the center of mass of the pendulum masses from the axis of rotation of the pendulum mass carrier and the oscillation length established by the oscillation path, results in a tuning of the centrifugal force pendulum device to a certain damping order, which is formed by the relationship of torsional vibration frequency and speed of rotation. As this occurs, the pivoting angle of the pendulum masses is limited due to the limited construction space available and the circumferential spacing between the pendulum masses.

Torsional vibration eliminators are also known in general, in which pendulum masses are received on a pendulum mass carrier rotatably in reference to a rotation axis running radially between the center of mass of the pendulum masses and the axis of rotation of the pendulum mass carrier, with the help of a swivel joint. In this case, the rotation axis is established by the swivel joint, the pendulum masses being linked to the swivel joint by means of levers. This arrangement makes it possible to bring about a purely rotational motion of the pendulum masses relative to the pendulum mass carrier, and thus a greater pivoting angle. On the other hand, a great deal of construction space is required due to the suspension of the pendulum masses on the swivel joint.

### BRIEF SUMMARY OF THE INVENTION

The object of the invention is to improve the elimination effect of a centrifugal force pendulum device, in particular with a view to optimal construction space utilization and increasing the pivoting angle of the pendulum mass.

Accordingly, a centrifugal force pendulum device having pendulum masses that are arranged axially on both sides of a pendulum mass carrier which is rotatable around an axis of rotation and form a pendulum mass pair is proposed, the pendulum mass pair being pivotable to a limited degree relative to the pendulum mass carrier along an arc-shaped oscillation path with the aid of at least two rolling elements that are able to roll in a single cutout or in different cutouts in the pendulum mass carrier, the oscillation path having a rotation axis that is stationary relative to the pendulum mass carrier and that is located at a radial distance from the pendulum mass. That makes it possible to achieve a greater pivoting angle and an improved elimination effect of the centrifugal force pendulum device, while the construction space requirement of the centrifugal force pendulum device is reduced in particular by the suspension using two rolling elements. The centrifugal force pendulum device can be positioned in or on a torsional vibration damper, or in a hydrodynamic torque converter, or in a clutch device, for example a wet clutch or a dual clutch, or even in a dual mass flywheel.

In one advantageous version of the invention, the rotation axis is at a radial distance from the axis of rotation and is located radially between the pendulum mass and the axis of rotation.

In another preferred embodiment of the invention, the rolling elements are designed as rolling elements that are able to roll in at least one cutout in the pendulum mass carrier, and in at least one cutout in each of the pendulum masses of a pendulum mass pair, the rolling elements being held at a fixed distance from each other by means of connecting elements. Advantageously, the rolling elements have at least two different diameters over their length, where, in particular, the smaller of the two diameters operates in the area of the pendulum mass and the larger in the area of the pendulum mass carrier. In particular, the rolling elements may be designed as stepped bolts.

In another preferred embodiment of the invention, the pendulum masses of a pendulum mass pair are attached to each other with the aid of a spacing element received in at least one cutout in the pendulum mass carrier and movable therein. This cutout may be the same cutout in which the rolling elements are received, or may be designed as a separate cutout in the pendulum mass carrier. The spacing element may be designed as a spacing bolt, which attaches the two pendulum masses of a pendulum mass pair to each other and keeps them separated axially. The cutout in the pendulum mass carrier which receives the spacing element is preferably designed so that the movement of the pendulum masses along the oscillation path is not hindered; however, it may abut on the spacing element in the cutout in such a way that it can enable a delimitation of the pivoting angle as the maximum pivoting angle.

Also, the development of noise upon impact of the pendulum masses when the maximum pivoting angle is reached can be reduced by suitable noise damping measures, for example, by damping an impact of the spacing element on the cutout by damping material introduced into the cutout or attached to the spacing element, for example, an elastic material, rubber or equivalent.

Also, a plurality of spacing elements may be received in one cutout, or in different, i.e., separate cutouts.

In another special embodiment of the invention, the rolling elements are designed as bolts having roller bearings placed thereon and able to roll in at least one cutout. Preferably, the bolts attach the pendulum masses of a pendulum mass pair to each other, and are firmly connected to the pendulum masses.

In a preferred form of the invention, the rolling elements of a pendulum mass pair are jointly received in one cutout of the pendulum mass carrier. The rolling elements of a pendulum mass pair may also each be received in different cutouts of the pendulum mass carrier. In this case, one rolling element may be able to roll, for example, in one cutout.

In another embodiment of the invention, the outside contour of at least one pendulum mass is formed of at least three circular arc segments, having a total of at least two different circular segment radii. Here an average outside radius may preferably be defined as the difference between the outside radius of the pendulum mass carrier and the oscillation interval, as the radial distance of the rotation axis from the axis of rotation, where the reference point of the outside radius is located in the rotation axis. The middle outside contour with the middle outside radius extends maximally in the circumferential direction over the arc length formed by the maximum pivoting angle in this circumferential direction.

On the circumferential side, lateral outside contours may abut on the middle outside contour on both sides of the center line, in each case as far as a lateral contour of the pendulum mass. The lateral outside contours may each have in particular a lateral outside radius as a circular segment radius, which corresponds to the outside radius of the pendulum mass carrier. In this case, the reference point of the lateral outside radius of the lateral outside contour is located preferably at the end point, facing the axis of rotation and facing away from the center line of the respective lateral outside contour, of the circular arc, viewed from the center line, and limited on the arc side by the maximum pivoting angle and described by the oscillation interval around the rotation axis.

The inside contour of the pendulum mass may have a middle section running in a straight line, in particular tangentially, to which lateral inside contours may adjoin on both sides of the center line, which have a circular segment radius as their lateral inside radius, which corresponds to the inside radius of the pendulum mass carrier. In this case, the reference point of the lateral inside radius of the respective lateral inside contour is located preferably at the end point, facing the axis of rotation and facing away from the center line of the respective lateral inside contour, of the circular arc, viewed from the center line, and limited on the arc side by the maximum pivoting angle and described around the rotation axis by the oscillation interval. The two lateral contours of the pendulum mass are in particular rectilinear and run radially, and link the outside contour to the inside contour.

In another preferred design of the invention, on the circumferential side at least two pairs of pendulum masses are situated adjacent to each other. Advantageously, at least two circumferentially adjacent pendulum masses are connected to each other through a guide element. The guide element may produce a rigid connection between the adjacent pendulum masses which is rotatable with respect to the latter by means of a swivel joint, where the pivot points of the swivel joints of the connections of one pendulum mass lie on a line that runs through the rotation axis, and the pivot points of the swivel joints of the adjacent pendulum mass connected thereto lie on a line that runs through its rotation axis. Here, the pivot points combined may form a parallelogram, a square or a rectangle.

Additional advantages and advantageous designs of the invention are derived from the description and the illustrations, in which accurately scaled representation has been dispensed with in the interest of clarity. All explained features are applicable not only in the indicated combination, but also in other combinations or by themselves, without departing from the framework of the invention.

### BRIEF DESCRIPTION OF THE DRAWINGS

The invention will be described in detail below with reference to the illustrations. The figures show the following:

FIG. 1a is a detail of a top view of a centrifugal force pendulum device in a special embodiment of the invention, in a zero state;

FIG. 1b is a detail of a top view of a centrifugal force pendulum device in a special embodiment of the invention, in a state with the pendulum mass deflected;

FIG. 2 is a detail of a top view of a centrifugal force pendulum device in another special embodiment of the invention;

FIG. 3 is a detail of a top view of a centrifugal force pendulum device in another special embodiment of the invention;

FIG. 4 is a detail of a top view of a centrifugal force pendulum device in another special embodiment of the invention;

FIG. 5 is a detail of a top view of a centrifugal force pendulum device in another special embodiment of the invention;

FIG. 6a is a top view of a centrifugal force pendulum device in another special embodiment of the invention, in a zero state; and,

FIG. 6b is a top view of a centrifugal force pendulum device in another special embodiment of the invention, in a state with the pendulum masses deflected.

### DETAILED DESCRIPTION OF THE INVENTION

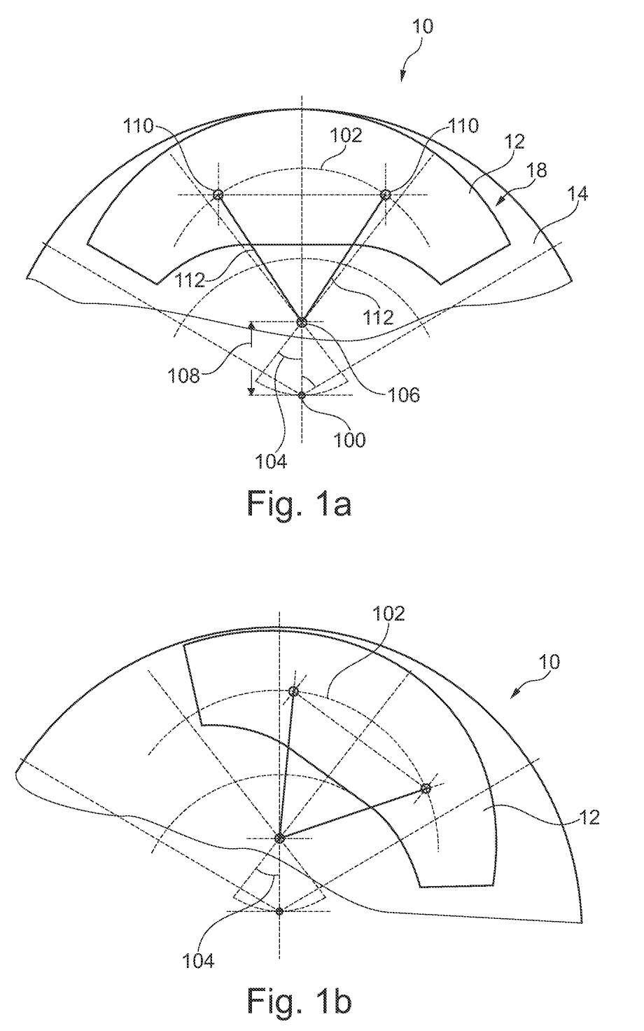

FIG. 1 shows a detail of a top view of a centrifugal force pendulum device 10 in a special embodiment of the invention, in a zero state. In this state, the pendulum mass 12 is not deflected relative to the pendulum mass carrier 14, and is in the centrifugal force field produced by the pendulum mass carrier 14 rotating around an axis of rotation 100 in a state of minimum potential, i.e., in a radially outermost position. The pendulum mass 12 is joined with a pendulum mass on the opposite side of the pendulum mass carrier 14 and, not visible in this depiction, into a pendulum mass pair 18.

The pendulum mass 12 is pivotable relative to the pendulum mass carrier 14 along the oscillation path 102 formed by a cutout in the pendulum mass carrier 14 with the aid of two rolling elements that are able to roll in the cutout, to a maximum pivoting angle 104. The oscillation path 102 takes the form of a circular arc, where the rotation axis 106 is fixed relative to the pendulum mass carrier 14 as the center of the circular arc, and does not change as the pendulum mass 12 moves along the oscillation path 102. The rotation axis 106 is located radially between the pendulum mass 12 and the axis of rotation 100, and has a radial distance from the pendulum mass 12 and the axis of rotation 12 as the oscillation interval 108.

To clarify the oscillation path 102 described by the oscillation mass 12, and the degrees of freedom of the motion, virtual suspension points 110 are sketched in here, with guide bars 112 between them which are to be understood as virtual and not actually present. The pendulum mass 12 is forced thereby into an oscillation path 102, which would correspond to the motion of a pendulum mass 12 that would be connected to the pendulum mass carrier 14 by two rigid guide bars 112 pivotable by means of a swivel joint with the center in the rotation axis 106.

FIG. 1b shows the embodiment of the centrifugal force pendulum device 10 from FIG. 1a in a state with the pendulum mass 12 maximally deflected. Here, the pendulum mass 12 is deflected on the oscillation path 102 by a maximum pivoting angle 104.

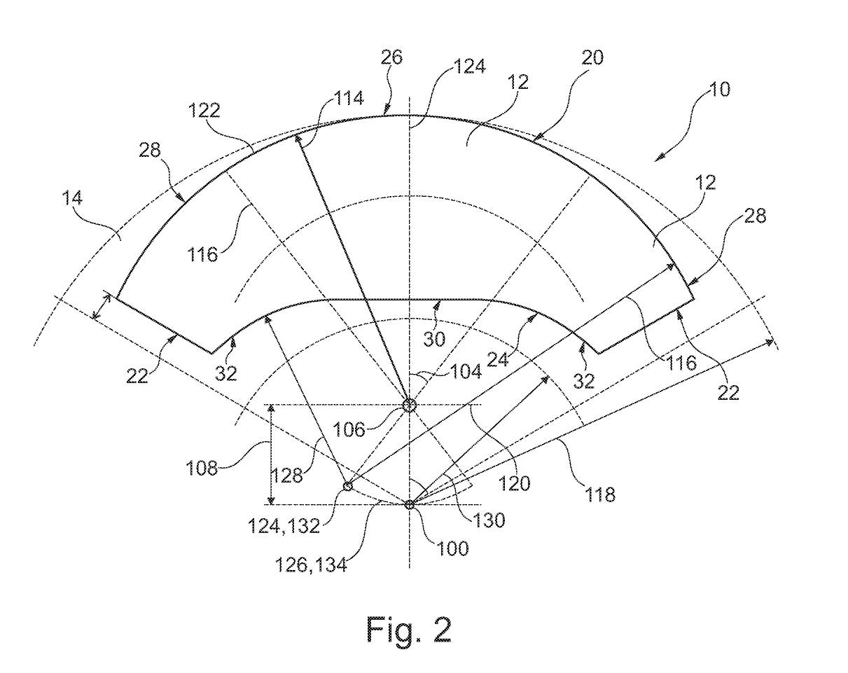

FIG. 2 shows a detail of a top view of a centrifugal force pendulum device 10 in another special embodiment of the invention. The size of the pendulum mass 12 is described by a radially outer outside contour 20, two lateral contours 22 and a radially inner inside contour 24. The outside contour 20 of the pendulum mass 12 comprises three circular arc sections having a total of two different circular segment radii, a middle outside contour 26 having a middle outside radius 114, and two lateral outside contours 28 having a lateral outside radius 116 that is the same but differs from the middle outside radius 114. The middle outside radius 114 of the middle outside contour 26 is preferably defined as the difference between the outside radius 118 of the pendulum mass carrier 14 and the radial distance of the rotation axis 106 from the axis of rotation 100, where the reference point 120 of the middle outside radius 114 is located in the rotation axis 106 and where the middle outside contour 26 with the middle outside radius 114 has an extent in the circumferential direction that corresponds to the arc length 122 limited by the maximum pivoting angle 104 in this circumferential direction.

On the circumferential side, on both sides of the center line 124 lateral outside contours 28 abut on the middle outside contour 26, in each case as far as the lateral contour 22 of the pendulum mass 12. The lateral outside contours 28 each have a lateral outside radius 116 as a circular segment radius, which corresponds to the outside radius 118 of the pendulum mass carrier 14. The reference point 124 of the lateral outside radius 116 of the lateral outside contour 28 is located in this case at the end point, facing the axis of rotation 100 and facing away from the center line 124 of the respective lateral outside contour 28, of the circular arc 126, viewed from the center line 124, and limited on the arc side by the maximum pivoting angle 104 and described around the rotation axis 106 with the oscillation interval 108.

The inside contour 24 of the pendulum mass 12 has a middle inside contour 30 running in a straight line, in particular tangentially, to which lateral inside contours 32 adjoin on both sides of the center line 124, which have a circular segment radius as their lateral inside radius 128, which corresponds to the inside radius 130 of the pendulum mass carrier 14. In this case, the reference point 132 of the lateral inside radius 128 of the respective lateral inside contour 32 is located at the end point, facing the axis of rotation 100 and facing away from the center line 124 of the respective lateral inside contour 32, of the circular arc 134, viewed from the center line 124, and limited on the arc side by the maximum pivoting angle 104 and described around the rotation axis 106 with the oscillation interval 108. The two lateral contours 22 of the pendulum mass 12 are in particular rectilinear and run radially, and link the outside contour 20 to the inside contour 24.

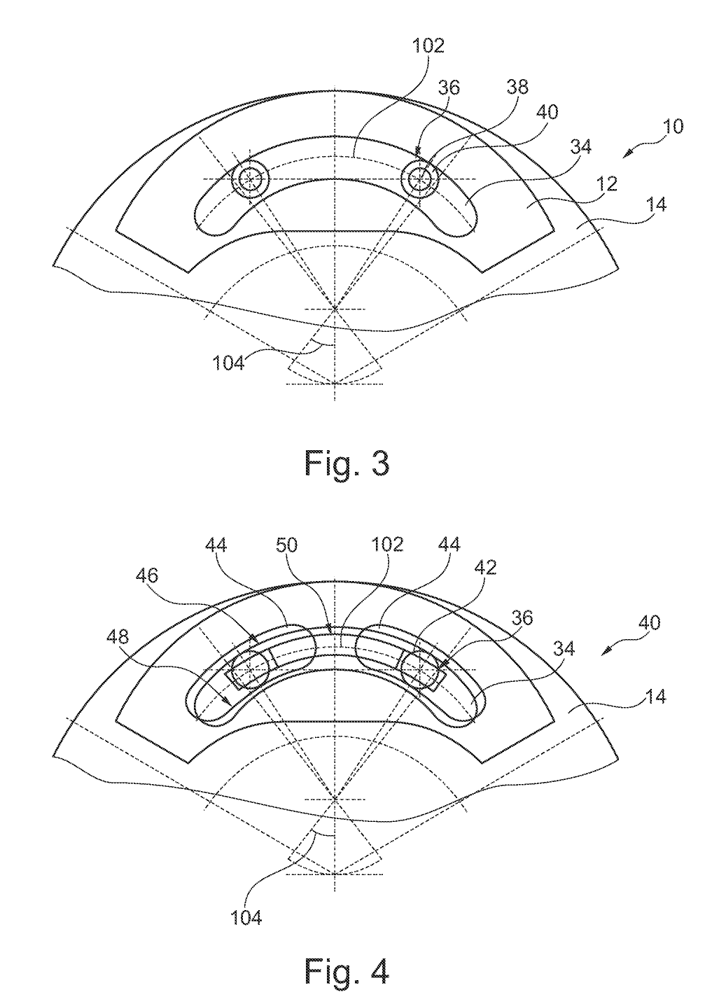

FIG. 3 shows a detail of a top view of a centrifugal force pendulum device 10 in another special embodiment of the invention. The pendulum mass carrier 14 has a single section 34 in the form of a circular arc. Attached to the pendulum mass 12 are rolling elements 36 in the form of bolts 38 firmly connected to the pendulum mass 12 and rolling bearings 40 received thereon, for example roller bearings, ball bearings or equivalent, where the rolling bearings 40 are able to roll in the cutout 34 so that movement of the pendulum mass 12 relative to the pendulum mass carrier 14 along the oscillation path 102 is enabled. In particular, the diameter of the rolling bearings 40 is smaller than the height of the cutout 34. The rolling elements 36 are spaced apart on the circumference, the interval preferably being smaller than two times the maximum pivoting angle 104.

FIG. 4 shows a detail of a top view of a centrifugal force pendulum device 10 in another special embodiment of the invention. A single cutout 34 is made in the pendulum mass carrier 14, in which the rolling elements 36 are able to roll. Two rolling elements 42 are provided as rolling elements 36, each of which are able to roll in different cutouts 44 removed from the pendulum masses 12. Under the influence of centrifugal force, the rolling elements 36 come into contact on the radial outer side 46 of the cutout 34 in the pendulum mass carrier 14 and on the radial inner side 48 of the cutout 44 of the pendulum mass 12. That means that the contours of these sides of the cutouts 34, 44 determine the shape of the oscillation path 102 and are preferably in the form of circular arcs and in particular are formed with the same radius. Also, the radially opposing sides of each cutout 34, 44 have essentially the same shape, which contributes to simplified production of the centrifugal force pendulum device 10.

Connecting elements 50 serve to keep the rolling elements 36 at a fixed distance from each other, the interval of the rolling elements 36 preferably being smaller than two times the maximum pivoting angle 104. The connecting elements 50 may be designed, for example, as a roller cage.

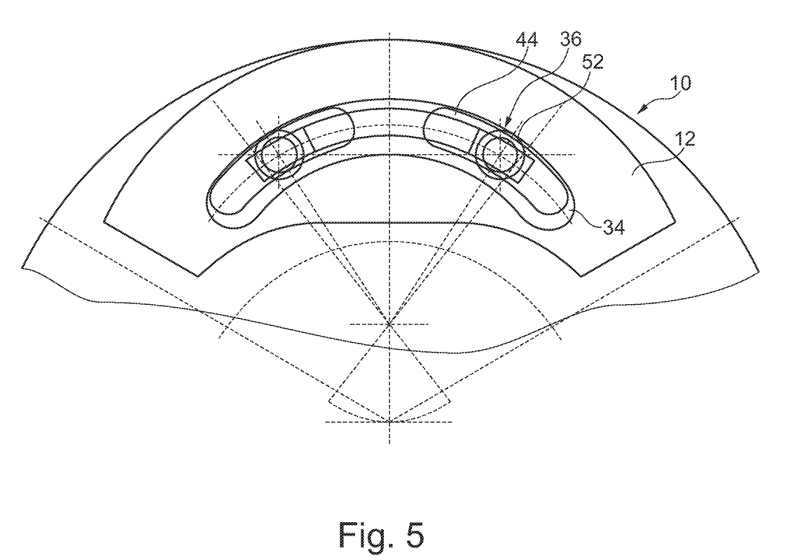

FIG. 5 shows a detail of a top view of a centrifugal force pendulum device 10 in another special embodiment of the invention. The embodiment here is similar to that in FIG. 4. Here, however, the rolling elements 36 are designed as stepped bolts 52, the diameter of the rolling element 36 in the area of the cutouts 44 of the pendulum mass 12 being smaller than the corresponding diameter in the area of the cutout 34 of the pendulum mass carrier 14. Accordingly, the cutouts 44 in the pendulum mass 12 can be of smaller design, which improves the pendulum mass 12 and thereby the eliminating effect of the centrifugal force pendulum device 10.

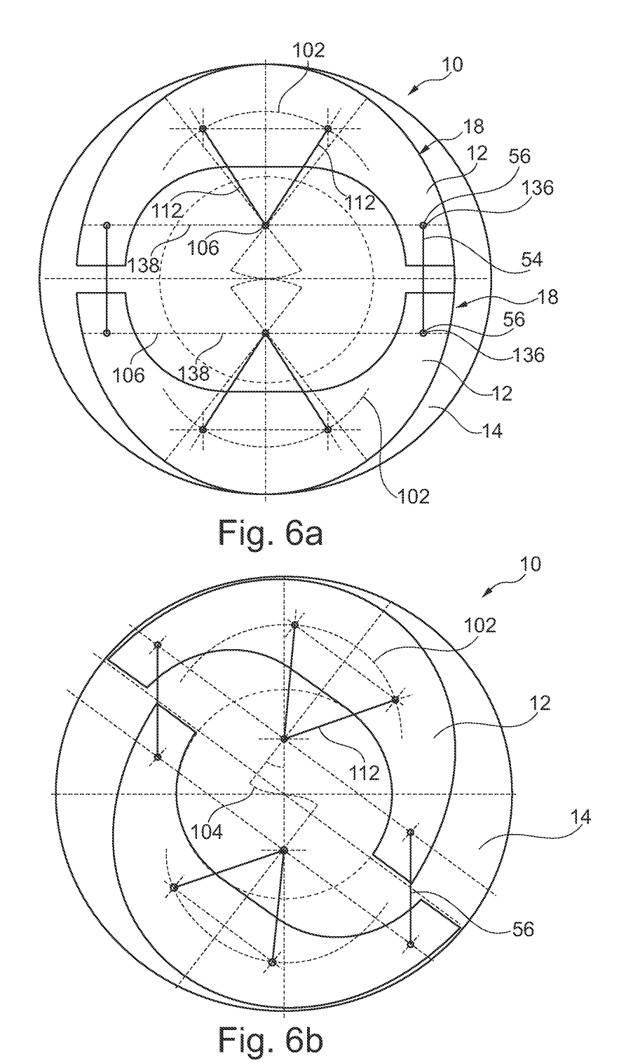

FIG. 6a shows a detail of a top view of a centrifugal force pendulum device 10 in another special embodiment of the invention, in a zero state. On the circumferential side, two pendulum mass pairs 18 are situated adjacent to each other and are connected with each other through two guide elements 54. The guide element 54 makes a rigid connection between the adjacent pendulum masses 12, which is rotatable relative to them by means of a swivel joint.

The pivot points 136 of the swivel joints 56 of these guide elements 54 on a pendulum mass 12 lie on a line 138 that runs through the rotation axis 106, and the pivot points 136 of the swivel joints 56 of the adjacent pendulum mass 12 connected thereto lie on a line 138 that runs through its rotation axis 106. It is preferable for the pivot points 136 combined to form a rectangle, whereas this gives way to a parallelogram when the pendulum masses 12 are deflected along their oscillation path 102, as shown in FIG. 6b at the maximum pivoting angle 104. The sketched in and virtual guide bars 112 serve to clarify the degrees of freedom of the motion of the pendulum masses 12 relative to the pendulum mass carrier 14, are in particular not actually present.

### REFERENCE NUMERALS

10 centrifugal force pendulum device
12 pendulum mass
14 pendulum mass carrier
18 pendulum mass pair
20 outside contour
22 lateral contour
24 inside contour
26 outside contour
28 outside contour
30 inside contour
32 inside contour
34 cutout
36 rolling element
38 bolt
42 rolling bearing
42 rolling element
44 cutout
46 outer side
48 inner side
50 connecting element
52 stepped bolt
54 guide element
56 swivel joint
100 axis of rotation
102 oscillation path
104 pivoting angle
106 rotation axis
108 oscillation interval
110 suspension point
112 guide bar
114 outside radius
116 outside radius
118 outside radius
120 reference point
122 arc length
124 center line
126 circular arc
128 inside radius
130 inside radius
132 reference point
134 circular arc
136 pivot point
138 line

What is claimed is:

1. A centrifugal force pendulum device (10), comprising:
a pendulum mass carrier (14) having a single cutout (34) which comprises at least two rolling elements (36) that are able to roll within said single cutout (34); and,
pendulum masses (12) forming a pendulum mass pair (18) which is arranged axially on both sides of said pendulum mass carrier (14) which is rotatable around an axis of rotation (100);
wherein said pendulum mass pair (18) is pivotable to a limited degree relative to the pendulum mass carrier (14) along an arc-shaped oscillation path (102) with the aid of said at least two rolling elements (36) that are able to roll in said at least one cutout (34) in the pendulum mass carrier (14), and wherein the oscillation path (102) has a rotation axis (106) that is stationary relative to the pendulum mass carrier (14) and that is located at a radial distance from the pendulum mass (12).

2. A centrifugal force pendulum device (10), comprising:
a pendulum mass carrier (14) having different cutouts which comprise at least two rolling elements (36) that are able to roll within said different cutouts; and,
pendulum masses (12) forming a pendulum mass pair (18) which is arranged axially on both sides of said pendulum mass carrier (14) which is rotatable around an axis of rotation (100);
wherein said pendulum mass pair (18) is pivotable to a limited degree relative to the pendulum mass carrier (14) along an arc-shaped oscillation path (102) with the aid of said at least two rolling elements (36) that are able to roll in said different cutouts in the pendulum mass carrier (14), and wherein the oscillation path (102) has a rotation axis (106) that is stationary relative to the pendulum mass carrier (14) and that is located at a radial distance from the pendulum mass (12).

3. The centrifugal force pendulum device (10) recited in claim 2, wherein the rolling elements (36) of a pendulum mass pair (18) are each received in different cutouts (34) of the pendulum mass carrier (14).

4. The centrifugal force pendulum device (10) recited in claim 1, wherein the rotation axis (106) is at a radial distance from the axis of rotation (100) and is located radially between the pendulum mass (12) and the axis of rotation (100).

5. The centrifugal force pendulum device (10) recited in claim 1, wherein the rolling elements (36) are designed as rolling elements (36) that are able to roll in said single cutout (34) in the pendulum mass carrier (14), and in at least one cutout (44) in each of the pendulum masses (12) of a pendulum mass pair (18), the rolling elements (42) are held at a fixed distance from each other by means of connecting elements (50).

6. The centrifugal force pendulum device (10) recited in claim 4, wherein the pendulum masses (12) of a pendulum mass pair (18) are attached to each other with the aid of at least one spacing element received in a cutout (34) in the pendulum mass carrier (14) and movable therein.

7. The centrifugal force pendulum device (10) recited in claim 1, wherein the rolling elements (36) are designed as bolts (38) with a rolling bearing (40) that is received thereon and is able to roll in at least one cutout (34).

8. The centrifugal force pendulum device (10) recited in claim 1, wherein the rolling elements (36) of a pendulum mass pair (18) are received jointly in one cutout (34) of the pendulum mass carrier (14).

9. The centrifugal force pendulum device (10) recited in claim 1, wherein an outside contour (26) of at least one pendulum mass (12) is formed of at least three circular arc segments, having a total of at least two different circular segment radii.

10. The centrifugal force pendulum device (10) recited in claim 1, wherein on a circumferential side at least two pendulum mass pairs (18) are situated adjacent to each other.

11. The centrifugal force pendulum device (10) recited in claim 10, wherein at least two circumferentially adjacent pendulum masses (18) are connected to each other through a guide element (54).
